(19) United States
(12) Patent Application Publication
(10) Pub. No.: US 2011/0039106 A1
(43) Pub. Date: Feb. 17, 2011

(54) TRANSPORTER FORM FOR BASE METAL PARTICLES AND USE THEREOF

(75) Inventors: Matthias Gruber, Geratskirchen (DE); Gert Rohrseitz, Zirndorf (DE)

Correspondence Address: ROBERTS MLOTKOWSKI SAFRAN & COLE, P.C.;Intellectual Property Department, P.O. Box 10064, MCLEAN, VA, 22102-8064, US

(73) Assignee: ECKA GRANULATE GMBH & CO. KG, Furth (DE)

(21) Appl. No.: 12/809,241

(22) PCT Filed: Dec. 19, 2008
(86) PCT No.: PCT/DE2008/002138

§ 371 Date: Oct. 19, 2010

(30) Foreign Application Priority Data
Dec. 19, 2007 (DE) 10 2007 061 236.4

(51) Int. Cl. B32B 15/02; B05D 7/00

(52) U.S. Cl. 428/407; 427/216; 428/403

(57) ABSTRACT

A transporter form for reactive metal particles, formed of metal particles and at least one coating produced of a material that does not enter into an oxidation reaction with the metal particles, in which coating the light metal particles are embedded and protected, and optionally other conventional additives, such as chain initiators, fillers and dyes are included. Also, a method for producing the transporter form, includes the steps of: size-reducing the base metal to give metal particles or flakes in the presence of the coating agent and while coating the metal particles so produced with a protective layer; and optionally, shaping transporter bodies using the coated metal particles/flakes. The transporter form can be used to produce corrosion-protective coatings on substrate surfaces; mixtures that can be sintered; and MIM mixtures.

### BACKGROUND OF THE INVENTION

1. Field of the Invention

The invention relates to a transportation form for reactive metal particles, methods for their preparation as well as their use.

2. Description of Related Art

In the following, the term “metals” shall mean both the elemental metals themselves and their alloys.

Many common metals, particularly alkaline earth metals are very reactive and oxidize rapidly in air and/or form hydroxides with the air humidity. Therefore, fine particles of these metals are manageable and storable only in protective gas or protection liquids due to their large surface area. Usually stored particles from alkaline earth metals or alloys thereof possess a thick oxide layer. With very fine or plate-like particles, which have a small thickness, the risk of complete oxidation exists, and thus, loss of the metallic properties. Thus, e.g., the functionality of the particles as a sacrificial anode in corrosion protection coatings is lost. The particles do not sinter or melt any more. However, coarse particles in corrosion protection coatings lead to surfaces with high surface roughness; with sinter parts, homogeneity is lacking and with MIM (Metal Injection molding) poor contour accuracy/high flow resistance occurs. Therefore, it desired to have fine particles and flake like particles from alkaline earth metals without an oxide or hydroxide layer available for use in paints or other applications, like e.g., MIM (Metal Injection Molding), and/or the preparation of mixtures with other metal powders, or to be able to transport and to use.

The preparation and especially storage of the particulate metals required for most diverse applications (included their alloys), especially of very reactive and very non-toxic metals and their alloys, like calcium and magnesium, are only possible under less favourable conditions. Therefore, atomization under protective gas, precipitation from solution or wet grinding or by cutting, milling, scratching or grinding is possible. The applicability of such common metals, especially alkaline earth metals is, however, reduced by their high reactivity in the metallic state. They can be stored only under less favorable conditions in a protective environment and as particle/air mixtures are especially explosive. Thus are their transport and the subsequent treatment, e.g., the introduction into e.g., coating compositions for protective coatings of any type is problematic.

Up to now, highly reactive metal particles were supplied in solvents or under protective gases, whereby both the preparation of the powders and of these transportation forms were subject to a high risk of explosions. It was also problematic when using solvent to remove the same when introducing it into a protective layer material—solvents must be disposed of pollution free, since they are usually prepared on basis of naphtha products, their price is coupled to petroleum. The major problem is the handling of the metallic reactive common metals, e.g., alkaline earth metals, in the introduction of the highly reactive sacrificial metal powders into the protective layer mass and/or on the substrate while having a minor loss of reactivity thereof or for sintering, optionally in mixture with other metallic powder parts to form a sinter alloy.

Herein, the term particles and small particles shall be understood as not being limited to approximately spherical particles but is intended to encompass also ellipsoidal, cubic, bar-like, disc shaped, prismatic, platelet-like (“flakes” or “slivers”) etc. and combinations of such shapes. If a particle is not spherical, its “diameter” shall be the diameter of a hypothetical area with a volume equal to that of the particle. “Flakes” are quasi two-dimensional forms (i.e., Forms having two large diameters and a small diameter). The expression shall mean herein also mixtures of particles of different composition and/or those, which have other forms and/or size distributions. They can have essentially constant particle size or not.

E.g., “magnesium particle” can include a mixture of two or more kinds of magnesium particles of various size distributions as well as flakes.

Although subsequently transportation forms for particular non-toxic corrosion protection coatings are described in detail, the invention is not limited thereto, but can used for any application, in which particulate metals are required to be used, so as, for example, for the preparation of decorative paints, conductive paints and coatings or for sinterable mixtures or Metal injection molding (MIM).

Metal injection molding (MIM) is a method, wherein metal powder—optionally with flow aids and/or bonding agents—is pressed into a mold to become a green compact. The green compact can be subsequently further processed—e.g., compressed further—and be sintered. Sinter parts are used in most diverse applications and increasingly replace cast and cut parts due to the simple production and high dimensional accuracy. With MIM, an oxide layer on the metal particles, which is brought as oxide particles into the component leads to weak points, is undesirable.

Sinter alloys can be also such metal particle mixtures, which do not melt homogeneously, but are producible in a sintered body and have new application possibilities compared to the known homogeneous melting alloys.

The sinter-in and/or handling of reactive metal particles in a sinterable metallic powder mixture was possible—due to the high reactivity—only under protective gas with high effort.

Another application of common metal particles is corrosion protection.

Corrosion can affect the strength and/or the appearance of metals affected thereby and of products prepared therefrom. Especially if polymer-plastic layers such as colors, adhesives or sealants are applied on metal, corrosion of the protected metal or the metal alloy (in the following: substrate metal) may lead to loss of adhesion between the polymer layer and the common metal. This adhesion is important, as the access of oxidative substances, like acids, oxygen, water etc. to the substrate is prevented thereby. Adhesion loss between the polymer plastic layer and the substrate metal can lead to further corrosion of the substrate metal. Especially if light metals and their alloys are used as substrate metals, these need corrosion protection due to their low electrochemical potential. To this purpose an improvement of the adhesion between the common substrate metal and coating layers laid thereon. All metals, but especially light aluminum and magnesium alloys now modern due to their light weight are corrosion susceptible. Additionally, the alloying elements improve the mechanical properties of the metal can still reduce their inherent corrosion resistance.

Corrosion is an electrochemical process that meets especially the so-called common metals and/or their alloys. Oxidation of a metal at its surface arises, which weakens and/or disfigures it. Most common metals are sufficiently reactive to change in normal environment—i.e., with a temperature in the order of magnitude of 0-20° C. and a normal humidity as well as standard atmosphere to convert to one of their oxide and/or hydroxide forms. With elevated temperatures or moisture content of the air this corrosion can accelerate significantly. It is known that frequently the generation of galvanic elements on the metal surface is essential. It has been observed that component corrosion is predominantly at junctions of the substrate metal with other materials, which arises when connecting the same with other metal parts like rivets, fasteners, clips, welding and brazing materials.

Major factors for corrosion include:

1. Metallurgic

Alloying elements, present holes, grain boundaries and/or a secondary phase; Chemical attacks (e.g., by hydraulic fluid, water, acid, atmospheric oxygen, atmospheric nitrogen etc.), galvanic corrosion (if metals of various electrochemical potential are in contact with one another) crevice corrosion, pitting corrosion.

2. Mechanical

Stress corrosion

Fatigue fractures and fatigue crack formation, like by oscillation corrosion and/or fatigue corrosion

3. Environmental conditions.

Climate, like temperature, moisture content, pH, electrolyte influence, salt influence as well as radiation intensity and—duration—e.g., with metal parts exposed to ionizing radiation.
Corrosion prevention can consist of:

Passivation: the substrate to be protected is encouraged to produce a passivating a layer as dense as possible, which prevents access of further oxygen or other oxidative materials such as water or the like. As a passivation layer, frequently phosphate or chromate coatings (“red lead”) were applied onto surfaces of common metal—either electrochemically or by chemical treatment of the substrate with solutions of tri- and hexavalent Cr compounds. Despite the success of chromates, the use of chromates is limited due to their carcinogenic nature and general toxicity. Strontium salts and similar have been used, too. These elements are very toxic, demand increased safety precautions when processing and even the disposal thereof is bound to many regulations.

4. Sacrifice materials:

A sacrificial layer is applied onto the substrate, which is oxidized instead of the substrate metal to be protected and/or reduces oxides of the same (“converts”). A typical “sacrificial layer” is the primer layer on steel sheets—i.e., layers, with oxidation-susceptible substances, like Zn, which oxidize easily, and thus, are oxidized in place of the metal to be protected (Fe alloy) and may even, optionally, reduce the same. Zinc is in higher concentrations and some of its compounds toxic and therefore likewise problematic. In the oxidized state, such sacrifice materials cannot exercise their protection effect any longer. Therefore, sacrificial layers have temporary limited effectiveness limited by the consumption of the oxidizable materials.

Today, high-strength corrosion-susceptible alloys of common metals, like iron alloys, in addition, light metal-alloys, like aluminum or magnesium alloys, are increasingly used in the construction of vehicles, the production of light housings, such as for laptops or cameras as well and similar high-quality apparatuses and in the construction industry (e.g., window profiles) and/or furniture industry due to the increase of lightweight construction. Many of these substrates are subject to stresses, that do not allow the formation of a protective passivation layer, e.g., with aluminum or magnesium and/or their alloys. E.g., the passivation layer my dissolve under the respective environmental conditions (e.g., salt water with ships) or the substrate does not form dense passivation layers (e.g., many iron and aluminum alloys) etc. These materials must be corrosion protected, whereas the provision of a sacrifice layer makes sense. The substrate metal parts are provided with a layer with sacrifice metal, whereas the protection essentially works at the contacts between substrate and sacrifice metal. On the protective layer frequently a “top coat” is applied. With vehicle sheet metal, normally, a layer structure with at least one conversion layer (primer) with particles of sacrifice metal, at least one pigment—or color-containing color-layer and at least one top layer is used.

Especially highly reactive and non-toxic metals, like the alkaline earth metals Ca and Mg as well as their alloys would, therefore, be excellent sacrificial layer components for the corrosion protection of noble substrates. Due to the fact that the electrochemical potential of these alkaline earth metals is very low, they can be used for the protection of a wide range of metal alloys. As discussed above, application of a corrosion protection layer takes place by applying a spreadable material—in form of a fluid or a viscous mass with the sacrificial metal particles on the substrate to be protected.

This protective layer mass can include most diverse materials, like particles of other metals, solvents, oxidation protection agents, chain starters, bonding agents as well as other polymer components, as known to the person skilled in the art on the field of the corrosion protection.

A typical sacrificial metal layer is known from German Patent Application DE 10 2006 044,706 A1. There, aluminum is used as a sacrificial metal for iron/cobalt/nickel alloys, which is encapsulated with substrate metal to avoid inhomogeneities in the oxidation-inhibiting layer with substrate metal, thereafter suspended in a polymer applied on the substrate. The encapsulation of the sacrificial metal particles with substrate metal is expensive and requires substrate dependent methods. A transportation form for elemental aluminum particles is not mentioned, but the particles have to be prepared in elemental form and immediately processed thereafter, making the production more difficult. Otherwise, activity losses by aluminum oxide layers have to be accepted. Therefore, it is desired to be able to provide a transportation form for common metals in particulate form (without metal encapsulation) for the most diverse applications.

### SUMMARY OF THE INVENTION

Therefore, it is an object of the invention to provide a transportation form for reactive metal particles which avoids the disadvantages of the state of the art. This object is met by a transportation form for reactive metal particles, characterized by metal particles and at least one coating from a material, which does not enter into an oxidation reaction with the metal particles, in which the light metal alloy particles are embedded and protected, comprising optionally other conventional additives, like chain reaction starting agents, fillers, dyes.

Furthermore the invention refers to a method to the production of the transportation form as well as to the use of this transportation form

Favorably, the common metal particles are selected from grain-like and flake-like particles as well as arbitrary mixtures of the same.

Typical particles have a diameter of 2-200μ, preferably of 2-100μ and particularly preferred 40μ and especially particularly preferred of 2-20μ.

The protective layer material can include also a bonding agent, a grinding aid or a flow aid, it is only important that it protects the surface of the metal, especially alkaline earth metal, against oxidation during transport and storage—at or during the application it may be reacted or removed.

With platelet-like metal particles, the protective layer material ideally is added directly during their preparation e.g., when grinding in ball mills. Both with dry grinding, as well as with wet grinding, the protective layer material deposits during the formation of flakes from the earth alkaline metal particles into flakes on the surface of the metal flakes and forms a protective coating.

The protective layer material can be e.g., a higher fatty acid and their esters, as e.g., stearic acid and stearates, oleic acids, additionally many other waxes, like polyamid waxes, polyethylene waxes, paraffins, amines/polyamines; amides/polyamides. Other preferred binders and protective agents for the transportation form are thermoplastic polymers.

A suitable thermoplastic polymer can be selected, however, is by no means limited on the group consisting of polyurethane and its precursors, especially polyisocyanates; Epoxy resin precursors; styrene block copolymers, polyetherester, polyetheramide (TPE-A) EPDM/PP mixtures, group of the synthetic rubbers, epoxy prepolymers; polyolefines.

It may be also useful that the bonding agent is an electrically conductive polymer or at least comprises it.

The platelet-like metal particles provided in such a way with a protective coating, especially alkaline earth metal particles, represent a transportation form to bring the particles directly into a metallic powder mixture or a coating material and make the final processing. Beyond that it is possible according to the invention, e.g., to embed plate-like alkaline earth metal particles in the protective coating in a thermoplastic material and to react it in this form into a coating material.

It can make sense that the protection polymer is an inorganic polymer. In this case, e.g., inorganic polymers on silicon basis or polyamides or polyamines are suggested. In others—obvious to the person skilled in the art—it is necessary that the protection polymer is an organic polymer.

Typical portions of metal particles in the transportation form lie for Mg between 40 and 90 wt. % and the portion of the bonding agent correspondingly between 10 and 60 wt. %, the remaining fillers etc., if present, are less than about 50 wt. %, whereby the portions are so selected that their sum amounts to always 100 wt. %. The numbers are material- and application-dependent and can be adapted by specialists.

In a preferred embodiment the metal is an alkaline earth metal selected from the group consisting of: Ca and Mg and their alloys as well as metal-mixtures therewith and mixtures of these materials with other metallic or non-metallic electrically conductive particles, especially aluminum. Mg and Ca have the advantage to be non-toxic and pose no problems with the proposal. In connection with this application Ca- or Mg-particles always also their alloys and mixtures with other conductive metal and nonmetal particles, especially aluminum are to be understood. A preferred use of such transportation forms is for the preparation of corrosion-preventing coatings on substrate surfaces. Additionally they can be used for other applications requiring elemental metals in unoxidized state required to become, used, e.g., for sinter mixtures.

With use of such transportation forms for the production of a coating e.g., the transportation form may be transformed into a fluids to viscous mass, optionally, mixed with other additions and applied as an easily spreadable mass onto the substrate. With thermoplastic polymers, this simply can take place via heating and kneading with the sacrificial metal particles—e.g., in an extruder, but also in a kneader, whereby the thermoplastic metal-containing material is formed in conventional manner to bodies—e.g., by forming via a nozzle into a strand. It is possible to obtain the desired consistency by adding a suitable solvent. It is also possible to overlay a polymer layer by a layer with sacrificial metal particles and these again by a polymer layer, whereby then a sandwich structure is made.

Also, so called flakes can be used—i.e., platelets of a length and/or width of 2-200μ, preferably 2-100μ and especially preferred of 40μ, and particularly especially preferred of 2-20μ and an height of 1-10μ, preferably 1-7μ, particularly preferred of 1-4μ. Flakes are obtainable especially through wet grinding in solvents. Flakes have the advantage that they adapt better to the contour of planar surfaces, enable thinner coatings and larger surface areas may contact the surface to be protected. Thereby, thinner, material-saving and nevertheless effective protective layers may be created.

The invention is not delimited to certain metals—by means of the transporter form according to the invention also highly reactive Zn-particles or Sn-particles can be transported and released at the usage site, without having to consider precautionary measures in transport of possibly self-igniting metal particles.

One particularly preferred application of the transportation form according to the invention is for Ca and/or Mg and/or their alloys and mixtures. The transportation form can include, in addition to the sacrificial metal, other materials, especially electrically conductive particles, e.g., a rare earth element, like Ce may be admixed.

It is often useful, especially if hard coatings, as lacquers, are to be produced with the alkali/alkaline-earth, the protective material being a precursor of a curable one- or multi-component resin or soluble therein.

Suitable mixing ratios can have a portion of metal particles between 50 and 80 wt. %, whereby the portion of the protective layer material, especially a thermoplastic resin, lies between 20 and 40 wt. %, and other fillers etc. have less than about. 40 wt. %; whereas the percentages are to be selected such that the sum of all portions amounts always to 100%. It is particularly preferred that the transportation form does not comprise toxic metals or metal ions.

As mentioned, the transportation form can (e.g., in addition to Mg or Ca-particles and/or their alloys and coating material) include bonding agents. The bonding agent can be each suitable polymer material (e.g., a polymer plastic or a copolymer) or a prepolymer (e.g., a monomer or an oligomer) or a combination of prepolymers, forming a polymer plastic or a copolymer after polymerization or copolymerization.

E.g., the bonding agent can also include one or more hybrid polymer matrices or other polymer plastic compositions or alloys, having a polymer plastic backbone with at least two types of reactive groups, which may take part in the crosslinking and polymerizing with different mechanisms; and/or the bonding agent can contain at least one prepolymer, that, after polymerization or copolymerization, forms the afore mentioned hybrid polymer matrix, hybrid polymer matrices or other polymer plastic compositions or alloys, e.g., the bonding agent includes a polyisocyanate prepolymer and an epoxy prepolymer in an embodiment of the invention.

Typical polyisocyanate prepolymers include, but are not limited to: bonding agents with a polyisocyanate prepolymer and an epoxy prepolymer. Useful polyisocyanate prepolymers include e.g., aliphatic polyisocyanate prepolymers, like 1,6 hexamethylene diisocyanate homopolymers (HMDI) trimer and aromatic polyisocyanate prepolymers, like 4,4′-methylenediphenylisocyanate (MDI) prepolymer. Combinations of two or more aliphatic polyisocyanate prepolymers, combinations of two or more aromatic polyisocyanate prepolymers, and/or combinations of one or more aliphatic and/or aromatic polyisocyanate prepolymers can also be used.

Useful epoxy prepolymers include any epoxy resin, like multi-function epoxy resins (epoxy resin with two or more epoxy groups/molecule). Examples of such epoxy resins include polyglycidylethers of pyrocatechins, resorcinol, hydroquinone, 4,4′-Dihydroxydiphenylmethane (or bisphenol F, like RE-404-S or RE-410 S (Nippon Kayuku, Japan), 4,4′-dihydroxy-3,3″-dimethyldiphenylmethane, 4,4′-dihydroxydiphenyldimethyl methane (or bisphenol A), 4,4′-dihydroxydiphenyl methyl-methan, 4,4′-dihydroxydiphenyl-4-cyclohexane, 4,4′-dihydroxy-3,3′-dimethyldiphenylpropane, 4.4′-dihydroxydiphenyl-4-sulfone and tris(4-hydroxyphenyl)methane; polyglycidylethers of transition metal complexes products of chlorination and bromination of the aforementioned diphenols; polyglycidylether of novolaks; polyglycidylether of diphenols, obtained by forming esters of diphenolether, obtained by forming esters of the salts of an aromatic hydrocarboxyl-acid with a dihalogenalkan or a dihalogendialkylether; polyglycidylether of polyphenols, obtained by condensation of phenol and long-chained halogen paraffins with at least two halogen atoms; N,N′ diglycidylanilin; N,N′ dimethyl N,N′ diglycidyl-4,4′-diaminodiphenylmethan; N,N,N′,N′-tetraglycidyl-4,4-diaminodi-phenylmethan; N,N′ diglycidyl-4-aminophenyl glycidyl ether; N,N,N′,N′-tetraglycidyl-1,3 propylene bis-4-aminobenzoat; phenol novolak epoxy resin; cresol novolak epoxy resin; and combinations thereof. Available in the trade are The as epoxy resins Polyglycidylderivates of phenolic compounds, like sold under trade names EPON 828, EPON 1001, EPON 1009 and EPON 1031, from Shell chemicals or DER 331, DER 332, DER 334 and DER 542 of Dow chemicals Co.; GY285 of CIBA special chemicals, Tarrytown, N.Y.; and BREN-S of Nippon Kayaku, Japan. Naturally also combinations of the aforesaid epoxy prepolymers and other epoxy prepolymers may be used. Monofunctional epoxy resins can be used e.g., as reactive dilution-agents or crosslinking-density-modifications.

The process according to the invention may also include reacting of the binder with crosslinkers.

Useful crosslinkers include, e.g., silanated tetrahydrochinoxalinole, like 7-phenyl-1 [4-(trialkylsilyl)-Butyl]-1,2,3,4 tetrahydrochinoxalin-6-ol and other 7-phenyl-1 [4-(trialkylsilyl)-alkyl]-1,2,3,4-tetrahydrochinoxalin-6-ols.

The reaction of the bonding agent/Mg/Ca mixture with the cross-linking agent can take place before or simultaneously with the application of the layer onto the metal surface. For example, the cross-linking agent and bonding agent in the coating formulation can be combined and the coating formulation (crosslinkers, magnesium particles or flakes, binder, etc.) can be applied in a single step. The at least one cross-linking agent may be applied alternatingly before or after applying the formulation according to the invention (sacrificial metal particle or flakes, binder, etc.) onto the substrate metal surface. Also alternating crosslinkers may be applied onto the metal surface before the coating formulation and the coating formulation may contain additional crosslinkers (in addition to the sacrificial metal particles, binder, etc.).

In use in a process according to the invention also hybrid binders can be used, as silane-modified epoxydiisocyanates form hybrid binders, which are bound to the substrate metal surface.

Although the above discussion is concentrated on organic binders, also inorganic binders may be used; “Bonding agent”, is to include organic binders, inorganic binder and combinations thereof. Applicable inorganic binders include the ones described by: Klein: “Inorganic zinc-rich” in L. Smith ed., Generic Coating Types: At Introduction ton of Industrial maintenance coating of material, Pittsburgh, Pa.: Technology Publication company (1996), whose teaching herewith is referred to in toto avoid of repetitions.

For example, inorganic binders with modified SiO2 structure (e.g., obtainable from silicic acid connections or silanes, which hydrolyze when affected by atmospheric moisture), may be used as inorganic binders. Other bonding agents include conductive binders e.g., from conductive polymer plastics, like doped polyanilin or doped polypyrrole. Other conductive bonding agents include organic polymer plastics or other polymer materials, which are doped with conductive pigment of small size, as carbon black. Also, conductive bonding agents with organic polymers, which are doped with a pigmenting form of a conductive polymer, can be used. It is assumed that the effective lifetime of such coatings having sacrificial-metal-rich conductive bonding agents is increased e.g., by strengthening the electrical connectivity to the substrate metal.

A typical method for the preparation of protective coatings on metal surfaces starting from a transportation form comprises:

Introduction of metal particles into softened thermoplastic resin obtaining good distribution thereof;

forming of bodies from the mixture and filling the molded bodies (transportation form). Mixing of predetermined amounts transportation form with at least one component of the protective coating and optionally solvent;

application of the mixture onto the surface to be protected and crosslinking/hardening of the polymer components in preparation of a crosslinked polymer with a predetermined content of metal particles.

It is particularly preferred that the transportation form possesses a prolonged shelf life and may be transported without problems, without concern for self inflammation, loss of metallic abilities of the metal located therein due to reactions with the ambient air etc.

If solvent or heat removable coating materials are used, e.g., paraffinol or fatty acids, they can be removed before the final use thermally or by solvents at the site.

Other objects, features and advantages result from studying the following detailed description in conjunction with the accompanying drawings.

### BRIEF DESCRIPTION OF THE DRAWINGS

FIG. 1 is a schematic representation of the process steps for the production of the transportation form;

FIG. 2 shows a scanning electron microscope photograph of Mg-Flakes on basis of Mg chips coated with stearic acid in 500× magnification;

FIG. 3 shows a scanning electron microscope photograph of Mg-flakes on basis of magnesium chips with stearic acid coating; and

FIG. 4 is a scanning electron microscope photograph of Mg-alloy flakes from with stearic acid coating from Magnesium alloy powder produced by gas-atomization.

### DETAILED DESCRIPTION OF THE INVENTION

In the following, preferred embodiments of the invention are described on basis of the production of Mg and Ca transportation forms are described—however, the invention is not limited thereto—according to this process, likewise, sodium, potassium, calcium, Zn, aluminum and other common metals and/or their alloys may be protected.

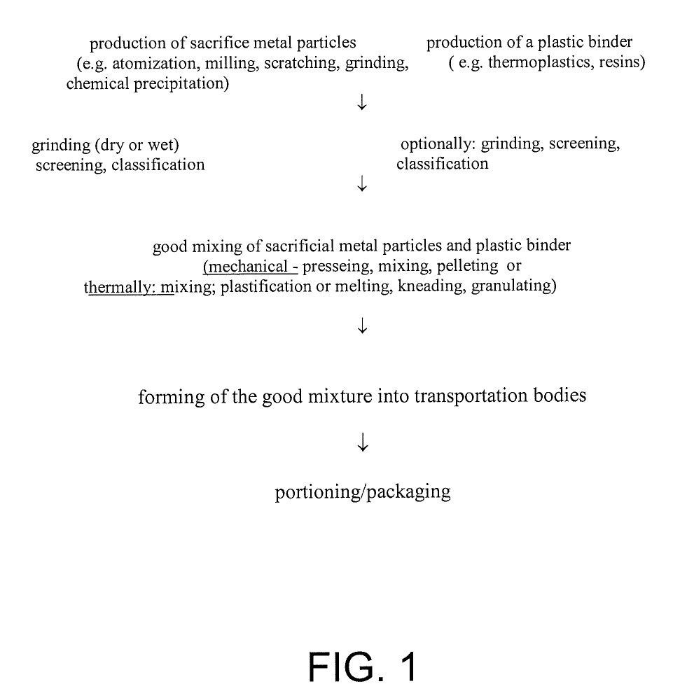

In FIG. 1, the process steps according to example 1 of the teaching of the invention in accordance with examples 1-5 are schematically illustrated. A polymer melt is provided through melting at elevated temperature; Mixing of the melt with metal particles and kneading at a weight ratio of polymer/metal of about 0.1-1.5 in an extruder. The mixture should be as homogeneous as possible, so that the polymer is mixed in the melt uniformly and in larger amounts. After mixing, the thus produced polymer/metal particle mixture is formed into transportation bodies, like films, granules, etc.

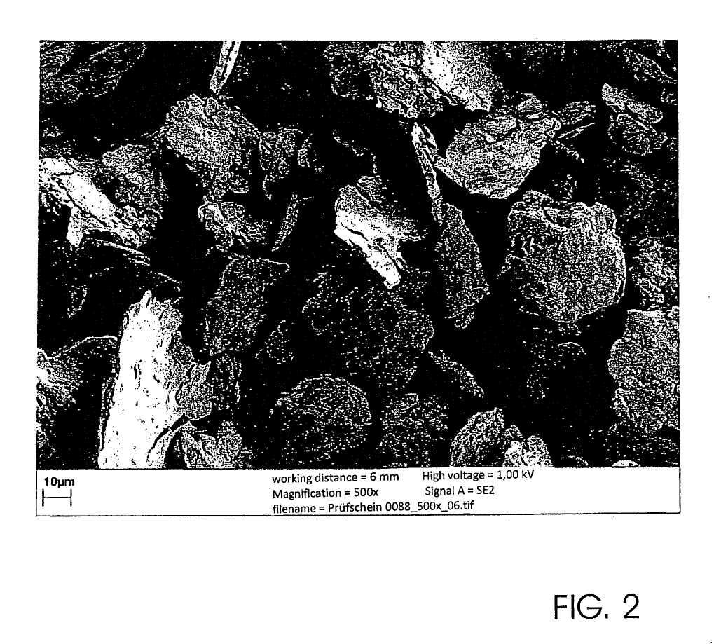

Typical magnesium flakes milled dry with stearic acid are shown in 500-fold magnification in FIG. 2. Apparently, the Flakes have been subjected to a strong mechanical stress, which leads to an uneven thickness and large surface area, whereby an oxidation without protective coating would be significantly promoted.

Suitable plants and their essential parts are known and known to the person skilled in the art.

A typical weight ratio polymer/sacrificial metal in the good mixture is about 0.1-1.5 for Mg/PU mixture; preferably 0.3-1.2.

### EXAMPLES

### Example 1

### Preparation of Mg-Transportation Bodies by Mechanical Mixing

Magnesium chips of 99.8% Mg having an average size of 175μ length and 40μ width are milled, so that an essentially equiaxial grain of an average grain size of 35μ develops. By classification, a grain fraction with <40μ is separated.

Epoxy resin having a particle size of <300μ epoxy is thoroughly mixed in a mixer in mass ratio Epoxide:Mg of 40:100 with the magnesium grain fraction <40μ.

The mixture is formed in a hydraulic press to give composite granules in form of hollow cylinders with outer diameter 15 mm and inner diameter 8 mm and an height of 11 mm. The green strength of these composite granules is as follows:

TABLE 1
Press parameter and green strength of the Composite granules

| | 1 | 2 | 3 |
|---|---|---|---|
| Pressing force (kN) | 7.9 | 8.3 | 8.8 |
| compacting pressure (g/cm) | 1.18 | 1.2 | 1.23 |
| green strength (MPa) | 4.27 | 5.15 | 6.00 |

### Example 2

### Composite Granules from Mg-Alloy by Mechanical Mixing

The method was performed as in example 1, as magnesium alloy was used an alloy of the composition:

### Al 5.9 wt. %

### Zn 3.1 wt. %

### Mn 0.21 wt. %

### Remainder Mg

### Example 3

### Transportation Form from Pure Magnesium and Epoxy Resin by Thermal Compounding

Magnesium particles, prepared as in example 1, having a grain size <40μ are introduced together with epoxy resin EPON® of a particle size <15 mm and a softening temperature of 82° C. into a planet roll extruder. In the first segment of the extruder the epoxy resin is heated to 120° heated and liquefied. In the 2nd segment a homogeneous mixture between liquid binder and metal particles is achieved at 120° C. In the third segment it is cooled down to 90° C.

The so formed transportation form material is drawn from the 3^{rd} segment in round and elongated structures. Over a cooling path in form of a modular link conveyor belt or vibratory feeder, the granulate is cooled down further and the structures are processed by breaking and screening to granulates of desired grain size. Alternatively, the viscous mass is transferred at the exit from the 3^{rd} segment into a granulator connected thereto and there granulates are formed and subsequently classified through screens. The so formed granulates are packaged.

### Example 4

### Transportation Form with Flake-Like Pure Mg-Particles

Mg-chips of a purity of 99.8%, as in example 1, are milled under inert gases under addition of a grinding adjuvant in an attritor for 2 hours. The particles—thus transformed to flakes—are screened to 200μ. The flakes are well mixed with epoxy resin in a screw extruder to obtain bodies with a Mg content of 63%.

### Example 5

### Ca-Transportation Form

Ca-chips of a purity of 99% of an average length of 325μ and 65μ width are comminuted by two-stage grinding to particles of average grain size of 125μ. By screening a fraction of <150μ is separated. This fraction is processed as in example 4 into Ca-transportation bodies.

### Example 6

### Transportation Form with Flake Like Particles of Pure Mg

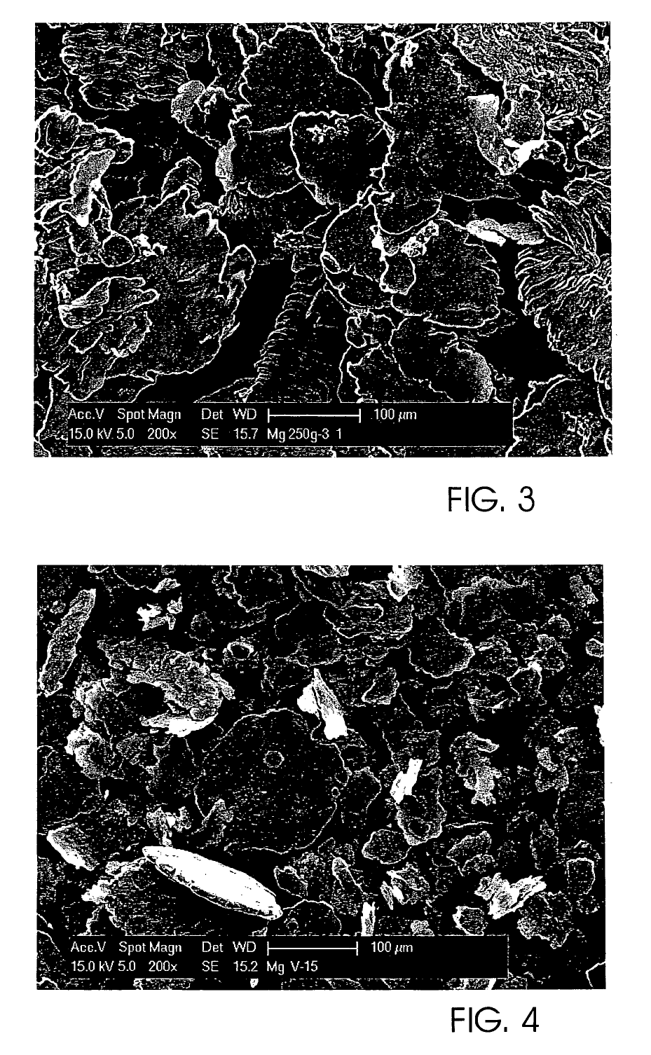

300 g Mg-chips of a purity of 99.8%, as in example 1, are wet-milled in white spirit under addition of 3 g stearic acid in an agitator ball mill 2 hours. By the shear stress in the mill, magnesium chips are transformed into Mg flakes and the stearic acid deposits on the newly formed metal surfaces so that it forms a coating. After grinding, the white spirit it is removed by sucking with a syphon and evaporation, so that the Mg flakes with a protective coating of stearic acid remain. A typical example of such magnesium particles obtained by grinding is shown in FIG. 3 which shows a scanning electron microscope photograph of Mg flakes with stearic acid coating in 200-fold magnification. Apparently, the magnesium chips had been subjected to stress—therefore, on the right side of the photograph particles torn by the stresses exerted by grinding/chipping can be seen.

### Example 7

### Transportation Form with Flake Like Particles of Mg Alloy

The method is as in example 6, however, 300 g gas atomized magnesium powder with an average particle size of 63μ of an alloy having the subsequent composition is used:

### Al 6.1 wt. %;

### Zn 2.8 wt. %;

### Mn 0.17 wt. %;

Remainder magnesium.

A scanning electron microscope photograph of such flakes of Mg alloy with stearic acid coating on basis of gas atomized magnesium alloy powder, scanning electron microscope at 200× magnification is shown in FIG. 4. It is clearly visible that magnesium atomized by gas did not suffer elongation and the particles have rather closed outer contours.

### Example 8

### Transportation Form of Flake Like Pure Magnesium Particles with Stearic Acid Coating, Embedded in Epoxy Resin by Thermal Compounding

Flake like pure magnesium particles in the transportation form of example 6 are compounded as in example 3 in a planet roller extruder with epoxy resin to granulate. The magnesium content of the thus obtained composite granulate is 30%.

It will be apparent that changes to the above specific embodiments, which have been shown for illustration of functional and structural principles of the invention, are possible without deviation of such principles. Therefore, the invention includes all embodiments embraced by the scope of the claims.

What is claimed is:

1-13. (canceled)

14. Transportation form for reactive light metal particles, comprising light metal particles and at least one coating protecting against oxidation, the at least one coating being of a material which does not enter an oxidation reaction with the light metal particles, and wherein the light metal particles are embedded in and protected by the at least one coating.

15. Transportation form according to claim 14, further comprising additives selected from the group consisting of chain starting agents, fillers, and dyes.

16. Transportation form according to claim 14, wherein the light metal particles are one of granular particles and flake particles and arbitrary mixtures thereof.

17. Transportation form according to claim 15, wherein the particles have a diameter of 2-200μ.

18. Transportation form according to claim 15, wherein the particles have a diameter of 2-100μ

19. Transportation form according to claim 15, wherein the particles have a diameter of <40μ

20. Transportation form according to claim 15, wherein the particles have a diameter of 2-20μ.

21. Transportation form according to claim 14, wherein the coating agent is reversibly removable from the metal surface by a method selected from the group consisting of burning, evaporating, melting, reacting, and dissolution by solvents.

22. Transportation form claim 14, wherein the coating agent is selected from the group consisting of inorganic coating agents, silicon based coating agents, organic coating agents, thermoplastic coating agents, and electrically conductive coating agents.

23. Transportation form according to claim 22, wherein the at least one thermoplastic organic coating agents is selected from the group consisting of polyurethane and its precursors, especially polyisocyanates; epoxy resin precursors; styrene block copolymers, polyetheresters, polyetheramide (TPE-A) EPDM/PP mixtures, synthetic rubbers, epoxy precursors; polyolefins, higher fatty acids and their derivatives, stearic acid and stearates; oleic acids, wax, polyamid waxes, polyethylene waxes, paraffine, amines/polyamides; and amides/polyamides.

24. Transportation form according to claim 14, wherein sacrificial metal particles comprise between 40 and 90 wt. % and the coating agent comprises between 10 and 60 wt. %, and other fillers comprise less than about 50 wt. %, whereas the sum thereof constitutes 100% of the transportation form.

25. Transportation form according to claim 14, wherein the light metal is selected from the group consisting of alkaline earth metals, Ca, Mg, their alloys and metal mixtures with these materials and with other light metals.

26. Method for the preparation of a transporter form for reactive light metal particles, comprising light metal particles and at least one coating protecting against oxidation, the at least one coating being of a material which does not enter an oxidation reaction with the light metal particles, and wherein the light metal particles are embedded in and protected by the at least one coating, comprising the steps of:
comminuting the common metal into at least one of metal particles and flakes in the presence of the at least one coating agent while coating the resulting prepared metal particles with a protective layer.

27. Method according to claim 26, comprising the further step of forming transporter bodies with the coated metal particles/flakes.

28. Method according to claim 26, wherein the comminution takes place in a solvent with coating material, which is evaporated while obtaining coated metal particles.
